(19) United States
(12) Patent Application Publication
(10) Pub. No.: US 2008/0079521 A1
(43) Pub. Date: Apr. 3, 2008

(54) Electromagnetic Actuator Comprising An Electromagnet With A Coil Secured To A Permanent Magnet, And A Method Of Assembling Such An Actuator

(75) Inventors: Christophe Maerky, Saint-Ouen L'Aumone (FR); Lucien Donce, Magny En Vexin (FR); Eddy Cheri-Zecote, Courbevoie (FR)

Correspondence Address: OSHA LIANG L.L.P., 1221 MCKINNEY STREET, SUITE 2800, HOUSTON, TX, 77010, US

(73) Assignee: Valeo Systemes de Controle Moteur, Osny (FR)

(21) Appl. No.: 11/596,946

(22) PCT Filed: May 23, 2005
(86) PCT No.: PCT/FR05/01273

§ 371 Date: Aug. 15, 2007

(30) Foreign Application Priority Data
May 24, 2004 (FR) 0405569

(51) Int. Cl. H01F 7/08

(52) U.S. Cl. 335/229

(57) ABSTRACT

An electromagnetic actuator comprising an actuator member (7, 8) movable under the action of at least one electromagnet (1) comprising a coil (3) associated with a core (2) arranged to channel magnetic flux generated by the coil (3) so that it loops through the actuator member, the coil comprising a winding (21) of conductor wire covered in a casing (20), and the electromagnet including at least one permanent magnet (4) disposed relative to the core (2) in such a manner that the core channels flux generated by the permanent magnet so that it loops through the actuator member. According to the invention, the casing of the coil covers at least part of the permanent magnet (4) in such a manner as to secure the permanent magnet (4) to the winding (21) of conductor wire, such that the conductor wire winding and the permanent magnet form a one-piece unitary assembly suitable for being fitted on the core.

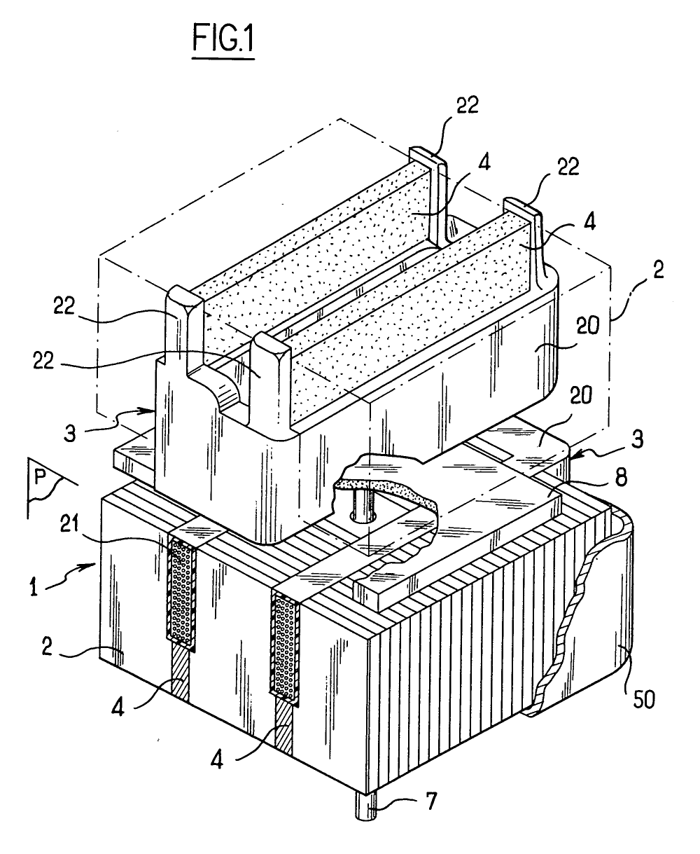

The invention relates to an electromagnetic actuator comprising an electromagnet with a coil that is secured to a permanent magnet, and to a method of assembling such an actuator.

### BACKGROUND OF THE INVENTION

Electromagnetic actuators are known that comprise an actuator member movable under the action of at least one electromagnet comprising a coil associated with a core arranged to channel magnetic flux generated by the coil so that it loops through the actuator member, the coil comprising a winding of conductor wire covered in a casing, and the electromagnet including at least one permanent magnet disposed relative to the core in such a manner that the core channels flux generated by the permanent magnet so that it loops through the actuator member.

Assembling the actuator thus requires numerous independent elements to be handled, thereby complicating assembly.

### OBJECT OF THE INVENTION

The invention seeks to provide an electromagnetic actuator for which assembly is simplified.

### SUMMARY OF THE INVENTION

According to the invention, an electromagnetic actuator of the above-specified type is provided in which the casing of the coil covers at least part of the permanent magnet in such a manner as to secure the permanent magnet to the winding of conductor wire, such that the conductor wire winding and the permanent magnet form a one-piece unitary assembly suitable for being fitted on the core.

This reduces the number of independent elements that need to be handled, thereby simplifying assembly.

The invention also provides a method of assembling an actuator comprising an actuator member and an electromagnet having a core, a coil comprising a winding of conductor wire, and an additional element, which method comprises the step of securing the additional element to the coil before assembling together the coil and the core.

### BRIEF DESCRIPTION OF THE DRAWING

The invention can be better understood in the light of the following description given with reference to the sole figure which is a partially cutaway perspective view of an actuator of the invention.

### DETAILED DESCRIPTION OF THE INVENTION

With reference to the sole figure, the actuator of the invention comprises two electromagnets 1 disposed facing each other, each comprising a core 2 constituted by a stack of laminations of ferromagnetic material. In the figure, the core of the top electromagnet can be seen only in the form of an outline drawn in chain-dotted lines. The electromagnets 1 are integrated in a case 50 obtained by overmolding the cores 2.

Each of the cores 2 has branches that are separated by recesses that form a housing in which a coil 3 extends.

The laminations constituting the cores 2 are cut so as to enable permanent magnets 4 to be inserted in the core. This can be seen particularly clearly for the bottom electromagnet where the coil 3 and the magnets 4 are shown in section on a plane P flush with the core, the permanent magnets 4 subdividing the laminations of the core 2 into three independent portions constituting a corresponding number of packets of laminations.

The actuator also comprises a pusher 7 slidably mounted in an insert in the central branch of the core 2 of the bottom electromagnet 1. The pusher 7 has a free end projecting from the case 50 for co-operating with an actuator element, e.g. an admission or exhaust valve in an internal combustion engine, while the other end of the pusher 7 is secured to an armature 8 that extends between the electromagnet 1.

When the actuator is in operation, the armature 8 moves between two extreme positions in which the armature 8 comes into contact with one or the other of the cores 2 of the electromagnets 1 under the effect both of the electromagnets 1 attracting the armature selectively and of springs (not shown) that act on the pusher 7 in order to return it towards an equilibrium position that is substantially halfway between the extreme positions.

Each of the coils 3 has a casing 20 covering a winding 21 of conductor wire. The casing 20 protects the conductor wire 21 and presents any electrical contact between the wire and the corresponding core 2. The casing 20 also serves to improve thermal continuity between the coil 3 and the corresponding core 2, by increasing the heat exchange area between these two elements.

According to the invention, the casing 20 has projections 22 that extend to receive the ends of the permanent magnets 4. The projections 22 secure the permanent magnets 4 to the coils so that the coil and the magnets together form a one-piece unitary assembly.

The casing 20 and the projections 22 of the coils are preferably obtained simultaneously by molding. To do this, the conductor wire winding 21 and the permanent magnets 4 are placed in a mold, and a non-conductive material (e.g. a polymer) is injected into the mold such that once it solidified it forms the casing 20 and the projections 22.

During assembly of the actuator, the already assembled-together packets of laminations are placed in a mold, a non-ferromagnetic material (e.g. aluminum) is injected into the mold, and once the material has solidified, it forms one of the half-cases forming the case 50 of the actuator. The packets of laminations are thus secured to one another and form the core of one of the electromagnets.

Thereafter, the one-piece unitary assembly constituted by the coil and the magnets is inserted into the half-case. This makes assembling the actuator of the invention particularly simple.

The invention is not restricted to the particular embodiment described above, but on the contrary covers any variant coming within the ambit of the invention as defined by the claims.

In particular, although the actuator shown has two electromagnets, the invention also applies to an actuator that has only one electromagnet.

Although it is stated that the projections cover only a portion of the permanent magnet (specifically in the example shown the ends of the magnets), the casing could cover the additional element entirely. Furthermore, the permanent magnet could be secured by means other than a projection, for example by a boss of the casing.

1. An electromagnetic actuator comprising an actuator member movable under the action of at least one electromagnet comprising a coil associated with a core arranged to channel magnetic flux generated by the coil so that it loops through the actuator member, the coil comprising a winding of conductor wire covered in a casing, and the electromagnet including at least one permanent magnet disposed relative to the core in such a manner that the core channels flux generated by the permanent magnet so that it loops through the actuator member, wherein the casing of the coil covers at least part of the permanent magnet in such a manner as to secure the permanent magnet to the winding of conductor wire, such that the conductor wire winding and the permanent magnet form a one-piece unitary assembly suitable for being fitted on the core.

2. An electromagnetic actuator according to claim 1, wherein the casing has projections each arranged to receive one end of the permanent magnet.

3. A method of assembling an actuator comprising an actuator member and an electromagnet having a core, a coil comprising a winding of conductor wire, and an additional element, the method including the step of securing the additional element to the coil before assembling together the coil and the core.
